(19) United States
(12) Patent Application Publication
(10) Pub. No.: US 2014/0095627 A1
(43) Pub. Date: Apr. 3, 2014

(54) Likelihood of Receiving a Timely Response

(71) Applicant: AVAYA INC., Basking Ridge, NJ (US)

(72) Inventor: Silvana D. Romagnino, Ottawa (CA)

(73) Assignee: AVAYA INC., Basking Ridge, NJ (US)

(21) Appl. No.: 13/630,886

(22) Filed: Sep. 28, 2012

(51) Int. Cl. G06F 15/16

(52) U.S. Cl. 709/206

(57) ABSTRACT

An apparatus and method for determining the likelihood that a first party will receive a timely response from a second party in response to a message initiated by the first party, and sending an indicator associated with the likelihood of receiving a timely response to a terminal associated with the first party. The likelihood of receiving a timely response can be determined from the response histories of the parties, the relationship of the parties, the types of messages and communication modalities, and presence information. The indicator also can be presented in conjunction with, or in addition to a presence indicator. Representative messages can include message-based communications such as text messaging, voice communications, and email communications. Timely responses can include the answering of a voice call, a return call, and reply to a message. Timeliness can depend on the communication modality that is used.

### TECHNICAL FIELD

The apparatuses and methods described below relate generally to the field of communication networks and presence-aware communication networks. More particularly, the apparatuses and methods relate to determining a likelihood of receiving a timely response in a network.

### BRIEF DESCRIPTION OF THE DRAWINGS

FIG. 1 is a block diagram of a computing device.

FIG. 2 is a block diagram of a network that includes a server for determining the likelihood of receiving a timely response.

FIG. 3 is a flow diagram of an example operation of a server for determining the likelihood of receiving a timely response.

FIG. 4 is a plan view of a display that includes an indicator of a likelihood of receiving a timely response.

### SUMMARY

The apparatuses and methods described herein can be used to determine a likelihood of receiving a timely response. A likelihood of receiving a timely response server determines the likelihood that a first party at a first terminal will receive a timely response from a second party to a message initiated by the first party. The likelihood of receiving a timely response server sends an indicator to the first party at the first terminal of the likelihood of receiving a timely response from a second party. The indicator can be presented to the first party, for example by displaying the indicator on the first terminal. The indicator can be combined with, or used in conjunction with, other indicators, for example presence indicators from a presence server.

A method of determining a likelihood of receiving a timely response can include determining a likelihood that a first party at a first terminal will receive a timely response from a second party to a message initiated by the first party and sending an indicator of the likelihood of receiving a timely response to the first terminal of the first party. The method can also include receiving data associated with presence information about the second party at a second terminal and the indicator can include the presence of the second party. The timely response by the second party can be a message-based communication, a voicemail, a return call, an email, the answering of the call from the first party, or an acceptance of a communication setup request message by the second terminal to communication request. The method can also include determining one or more factors that affect the likelihood of receiving a timely response and the indicator can be based at least in part on one or more of the factors. Suitable factors can include a relationship factor of the two parties, a history factors related to previous communications between the parties, a rank factor of a message, an importance factor of the communication to one of the parties, a presence factor of the second party, a location factor of one or more of the parties, a relevance factor of the second party to an activity of the first party, an activity factor of the second party, and priority factor related to the priority of the second party in relation to the activity of the first party. The method can further include receiving presence data and basing the likelihood of receiving a timely response on the presence of the second party. A rank factor can be based on a priority factor such as an importance setting or urgency setting of a message, or can be based on a confidentiality setting of the message. An activity factor can be based on a collaboration or project of the parties and can include a communication modality such as a voice call, a conference call, an ongoing message dialog and email between the parties. A location factor can be the location of one of the parties, a location of a terminal associated with the second party, or the location of a terminal that is proximate to the location of the second party. A history factor can include information useful for determining trends in responses in communications between the parties such as the history of the second party in responding to communication attempts by the first party, history of the second party in responding to communication attempts by other parties, the recent response history of the second party to communication attempts by the first party, response history once the parties are working on a project together or otherwise working in collaboration with one another, and response history based on the time of day, a location of the second party, an activity of the second party, and the mode of communication being used. An indicator can be based on the likelihood that the second party will answer a call from the first party, will respond to a communication request, will respond to a message, or will respond within one or more threshold intervals of time. The indicator can further be a color, a shading, a percentage, a step-ranking indicator, a positive indicator or a negative indicator. The operation of determining the likelihood of receiving a timely response can be performed in accordance to one or more user policies, business policies, rule-based policies, and learning algorithms. A user policy can be a sender based policy based on a confidentiality setting, an importance setting, and an urgency setting. A user policy can be a receiver based policy based on an identification of the first party, a relationship of the parties, an activity of one or both of the parties, an activity of a party identified in the communication, a mode of collaboration of the parties, and a location of one or both of the parties. A business policy can be based on a communication type, a message type, or an identify of one of the parties.

A method of determining a likelihood of receiving a timely response can include displaying at a first terminal an identifying indicia of a party of interest associated with a second terminal, and displaying in proximity to the identifying indicia a prediction of the likelihood of receiving a timely response from the party of interest in response to a message being sent from the first terminal to the second terminal. The likelihood of receiving a timely response can be determined by applying a rule to one or more factors that correlate with the likelihood of receiving a timely response from the second party. The identifying indicia can be a name of the party of interest, a pseudonym of the party of interest, an address of the party of interest, and a telephone number of the party of interest. The method can further include determining one or more factors that affects the predicted likelihood of receiving a timely response, and basing the likelihood on one or more factors, that can include the determined factors. Factors can include the relationship of the parties, the availability of the parties at a terminal, an activity of one of the parties, prior communications between the parties, and priority indicators associated with messages. The method can also include receiving data associated with the presence of the party of interest and basing the predicted likelihood of receiving a timely response on the presence data. The method can also include displaying a presence identifier at the first terminal in proximity to the identifying indicia and the indicator of the likelihood of receiving a timely response.

An apparatus can include a processor configured to determine the likelihood of receiving a timely response from a second party to a message initiated by the first party, and a transmitter configured to send an indicator associated with the likelihood of receiving a timely response to the terminal of the first party. The apparatus can also include a receiving configured to receive data that correlates with the likelihood of receiving a timely response, for example data received from a data store or a presence server. The data can be received as a result of a querying operation. The processor can be configured to determine the likelihood of receiving a timely response using the data that is received, for example by applying one or more rules using the data. The apparatus can be further configured to determine one or more factors that affect the likelihood of receiving a timely response and the indicator can be based at least in part on one or more of the factors. Suitable factors can include a relationship factor of the two parties, a history factors related to previous communications between the parties, a rank factor of a message, an importance factor of the communication to one of the parties, a presence factor of the second party, a location factor of one or more of the parties, a relevance factor of the second party to an activity of the first party, an activity factor of the second party, and priority factor related to the priority of the second party in relation to the activity of the first party.

### DETAILED DESCRIPTION

The apparatuses, devices, systems and methods disclosed and described in this document can be used determine a likelihood of receiving a timely response and send an indicator of the likelihood of receiving a timely response to a terminal. The indicator can be presented to the user on a display of the terminal. Those of ordinary skill in this art area will recognize from reading this description that the apparatuses, devices, methods, and systems described can be applied to, or easily modified for use with, other types of equipment, other arrangements of computing systems such as client-server, peer-to-peer, or distributed systems, other protocols, and at other layers in communication protocol stacks.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term software is used expansively to include not only executable code, but also data structures, data stores and computing instructions in any electronic format, firmware, and embedded software. The terms information and data are used expansively and includes a wide variety of electronic information, including but not limited to machine-executable or machine-interpretable instructions; content such as text, video data, and audio data, among others; and various codes or flags. The terms information, data, and content are sometimes used interchangeably when permitted by context. It should be noted that although for clarity and to aid in understanding some examples discussed below might describe specific features or functions as part of a specific component or module, or as occurring at a specific layer of a computing device (for example, a hardware layer, operating system layer, or application layer), those features or functions may be implemented as part of a different component or module or at a different layer.

The examples discussed below are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

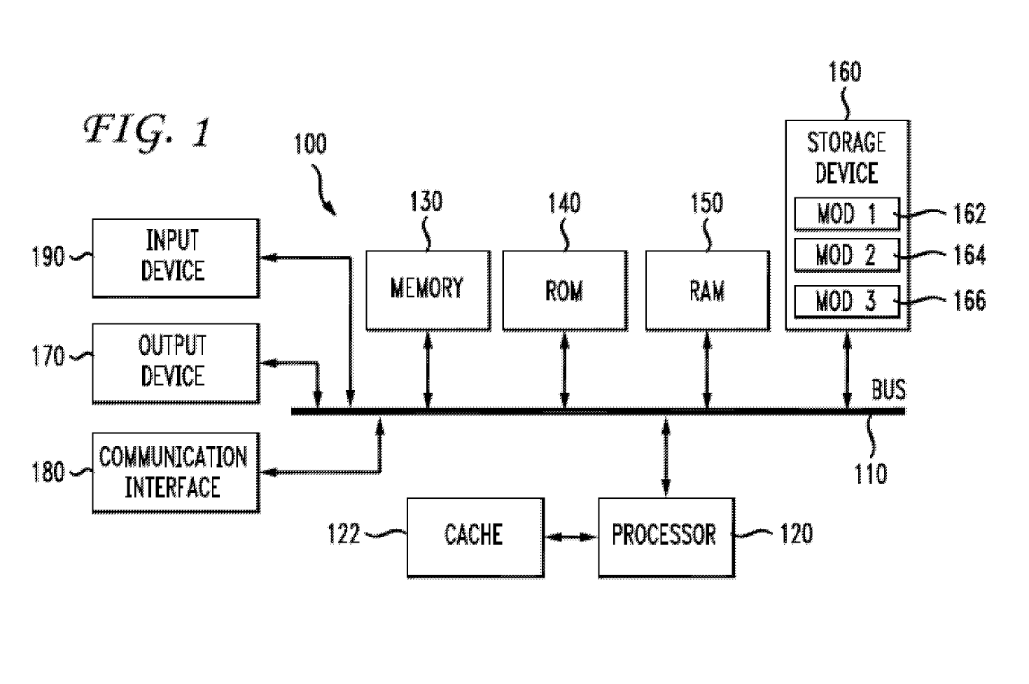

FIG. 1 illustrates an exemplary computing device 100. A computing device 100 can be a desktop computer, a server, a mobile computing device such as a smartphone, or any other suitable computing device as would be understood in the art. The computing device 100 includes a processor 120 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others.

The computing device 100 also includes one or more memories 130, for example read only memory (ROM) 140, random access memory (RAM) 150, cache memory 122 associated with the processor 120, or other memories such as dynamic RAM (DRAM), static ram (SRAM), flash memory, a removable memory card or disk, a solid state drive, and so forth. The computing device 100 also includes storage media such as a storage device 160 that can be configured to have multiple modules 162, 164, 166, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 120 or memories 130 are also contemplated as storage device 160.

The memory 130, processor 120, and storage drive 160 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

In various configurations, the computing device 100 can include a system bus 110 for interconnecting the various components of the computing device 100, or the computing device 100 can be integrated into one or more chips such as programmable logic device or application specific integrated circuit (ASIC). The system bus 110 can include a memory controller, a local bus, or a peripheral bus for supporting input devices 190, output devices 170, or communication interfaces 180. Example input devices 190 and output devices 170 include keyboards, keypads, gesture or graphical input devices, motion input devices, touchscreen interfaces, displays, audio units, voice recognition units, vibratory devices, computer mice, and any other suitable user interface.

The communication interface 180 allows the computing device 100 to communicate with other device across a network. The communication interface 180 can be an Ethernet interface, a radio interface, a telephony interface, a Universal Serial Bus (USB) interface, or any other suitable communications interface. Example communication interfaces 180 can includes wired data transmission links such as Ethernet and TCP/IP, as well as PSTN communications links such as T1s (or better), integrated services digital network (ISDN), Digital Subscriber Line (DSL), or dialup modems that implement, for example, the point-to-point protocol (PPP). The communication interface 180 can include wireless protocols for interfacing with private or public networks. For example, the communication interface 180 and protocols can include interfaces for communicating with private wireless networks such as a WiFi network, one of the IEEE 802.11x family of networks, or another suitable wireless network. The communication interface 180 and protocols can include interfaces for communicating with public wireless networks, such as cellular networks.

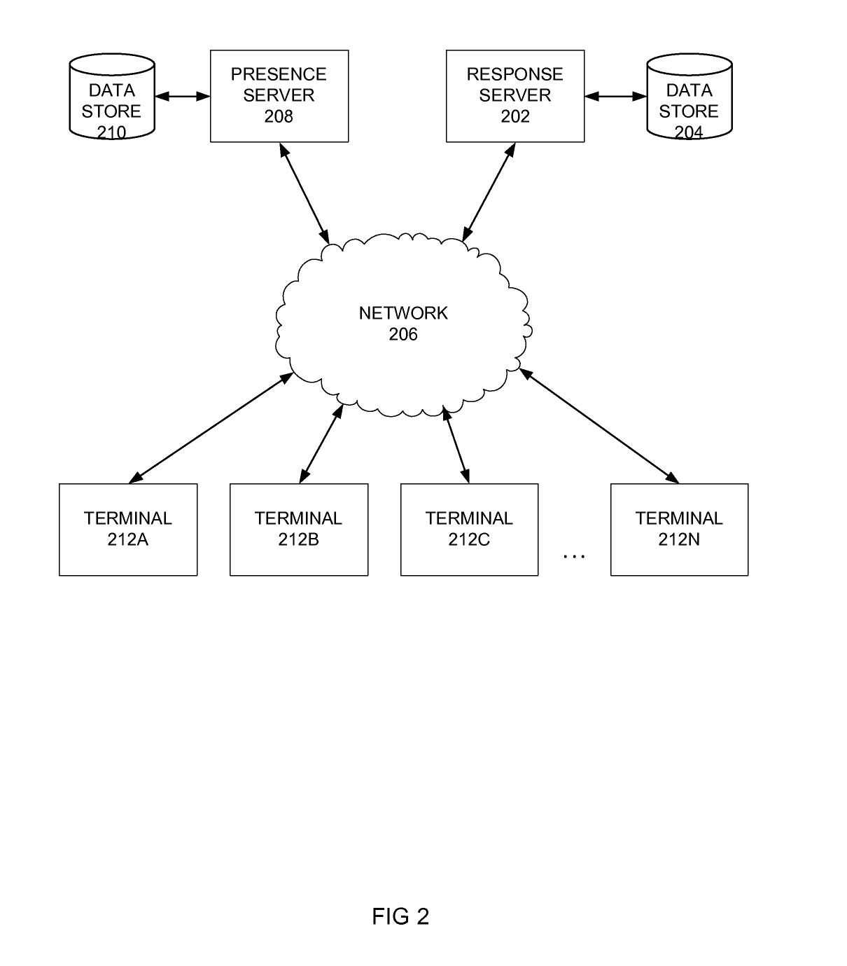

FIG. 2 illustrates a block diagram of network 206 that includes a likelihood of receiving a timely response server 202, or LRTR server 202. Although illustrated as a single network, the network 206 can be a public network, a private network, an enterprise network, an intranet, the Internet, a telephone network, a cable network, a wireless network, a packet-switched network, a circuit-switched network, or any suitable combination of networks. Example networks can include an asynchronous transfer mode (ATM) network, a packet-switched network running, for example, the TCP/IP suite of protocols, a session initiation protocol (SIP) capable network, a wireless network running one or more of the IEEE 802.11x family of protocols, a cellular network using code division multiple access (CDMA or CDMA:2000), global system for mobile communications (GSM), a cellular network running a 3G or 4G protocol, or another suitable network, including networks running on protocols currently in development or yet to be developed.

Computing devices 100 using the network 206 can be configured to use secure communication protocols such as Internet Protocol security (IPsec), Secure Sockets Layer (SSL), Transport Layer Security (TLS), secure hypertext transfer protocol (HTTPS/1.1) or any other suitable encrypted protocol. Encryption can also be performed using a suitable type of cipher, including a private key cipher, a symmetric private key cipher, a public key cipher, and an elliptic curve cipher, among others. Specifically, encryption can be implemented using the Advanced Encryption Standard (AES), the Data Encryption Standard (DES), triple DES (3DES), or another suitable cipher.

Each terminal 212A, 212B, 212C, . . . , 212N (collectively terminals 212) can be a computing device 100. A terminal 212 can include an output device 170 such as a display. A terminal 212 can be any suitable type of telephony capable terminal, including but not limited to a desktop phone, an IP phone, a mobile computing device, a mobile phone, a laptop, and a desktop computer.

An LRTR server 202 can determine the likelihood that a first party will receive a timely response from a second party in response to a message sent to the second party. The LRTR server 202 sends one or more indicators about the second party to a terminal 212 associated with the first party. The terminal 212 displays the indicators to the first party.

The displayed indicators provide the first party with information about the second party, allowing the first party to make intelligent decisions as to whether to attempt to contact the second party. The first party can review the indicators on the display prior to attempting to contact a second party, for example at the second terminal 212B. For example, if first party desires to contact the second party, but the indicators indicate that the second party is unlikely to answer or respond to the communication attempt in a timely manner, then the first party can decide to call at a different time, or call a different party instead. For example, if the second party is unlikely to respond in a timely manner, but a third party at a third terminal 212C is likely to respond to the first party, the first party may decide to attempt to contact the third party instead. The displayed indicator can inform a party as to whether an attempted communication to another party is likely to be successful or a waste time. The displayed indicator can help a party use their valuable time more productively.

The LRTR server 202 can receive information from the terminals 212, a presence server 208, and other sources that can be used to determine the likelihood of receiving a timely response. The LRTR server 202 can store this information in a suitable format in a data store 204 associated with the LRTR server 202. The LRTR server 202 can be any kind of suitable server, including a virtual server operating over a network, or multiple servers. The LRTR server 202 can support a number of terminals 212. The LRTR server 202 can also be implemented on a terminal 212. If implemented in whole or in part on a terminal 212, in various configurations the LRTR server 202 can use only information available on the terminal 212, can share information with one or more other terminals 212, or can use a shared data store 204 with other terminals. The data store 204 can be any suitable kind of data store including a memory, a server, or multiple memories or servers.

The LRTR server 202 can provide one or more indicators to a first terminal 212A associated with the first user prior to a message being sent to the terminal 212B associated with a second user. For example, if a first party at a first terminal 212A activates the first terminal 212A to display a selection that includes a second party to be contacted, then the LRTR server 202 can determine the likelihood of receiving a timely response from the second party and send an indicator associated with that likelihood to the first terminal 212A. If the first party activates the first terminal 212A to display a list of parties, then the LRTR server 202 can provide indicators of the likelihood of receiving a timely response from each party in the list of parties.

Each indicator can be associated with a particular modality to be used in contacting the second user. The LRTR server 202 can provide one or more indicators of the likelihood of receiving a timely response for each type of message or modality. Example modalities include voice calls, instant messaging, email, and so forth. A message can be any suitable kind of message used for the particular modality. For example, a message can be an instant message such as a text message, a short message service (SMS) message, or a multimedia message service (MMS) message, an email message, a multimodal message that can include images, video, audio, or attachments, a voice message, a voice call, a call setup message, a signal, a protocol specific message, or other suitable messages. For each party of interest to the first party, the LRTR server 202 can provide multiple indicators that each indicate a different likelihood of receiving a timely response from a party of interest based on whether the message to be sent is an instant message, an email, a voice call, and so forth.

An indicator can also be independent of the modality, and can be for example a single indicator representing the likelihood of receiving a timely response from a party of interest. The single indicator can be based on an aggregate of indicators for each modality, a mean of the likelihood for each modality, the median of the likelihood for each modality, or any other suitable derived value. The single indicator can also be the likelihood for a particular modality, for example the indicator can be based on the most likely modality to be used by the user, or the previous modality used. For example, if a user typically sends instant messages to a particular party of interest, then the single indicator can be initially set to display the likelihood of receiving a timely response for the instant message modality. In another example, if the last modality used to communicate with the party of interest was a voice call, then the indicator can be initially set to the voice call modality. The single indicator can also be set to the modality that has the highest likelihood of receiving a timely response, thereby providing guidance to the user as to which modality they should use to have the best chance of receiving a timely response.

The LRTR server 202 can provide the indicator to the terminal 212 at any suitable time. For example, the LRTR server 202 can provide the indicator to the terminal 212 once the party of interest is displayed on the terminal 212A of the first party. In another example, the LRTR server 202 can provide indicators to a terminal 212 based on entries in that party's address book, frequently contacted parties at that particular terminal, and so forth. The LRTR server 202 can also send an indicator to a terminal 212 when the LRTR server 202 identifies a change of state or an update in information relating to a party of interest.

The LRTR server 202 can send indicators based on what would be appropriate for the particular type of terminal 212 or user of the terminal. For example, if a terminal 212 is a mobile device, indicators can be sent only when needed to reduce traffic on the mobile network. In another example, if a terminal 212 is a desktop phone on a wired network, the LRTR server 202 can send indicators more frequently as network costs are generally lower. For example, the LRTR server 202 can send all indicators for parties listed in a party's address book to that party's terminal. In another configuration, the LRTR server 202 can send indicators to every wired terminal 212 and each terminal 212 could determine whether or not to use the received indicator. For example, if the indicator is not related to a party listed in a party's address book, then the terminal 212 associated with the party can ignore the indicator.

The terminal 212A of the first party receives one or more indicators from the LRTR server 202. One or more indicators can be received in one or more messages and each indicator can include an icon or image to be displayed by the terminal 212A. An indicator can be any suitable value, image, or set of values, images, or combinations of values and images. For example, an indicator can be a numerical value, such as a percentage value or rank value. An indicator can include a shading indicator, or a color indicator such as green, yellow, red, blue, and so forth. An indicator can be a positive indicator or a negative indicator. An indicator can include a step-ranking, for example a set of values indicating the likelihood of receiving a timely response with several different time thresholds such as a first percentage for an immediate response, a second percentage for a response within 5 minutes, and a third percentage for a response within 30 minutes. An indicator can include a graphical image depicting the likelihood of receiving a timely response. An indicator can be based on the probability of receiving a timely response being greater or less than a threshold value. An indicator can be based on the likelihood of receiving a response within a threshold period of time.

An indicator can be displayed as solid color, be shaded or have markings, include overlapping icons, be flashing, or use other suitable techniques for conveying status information. An indicator can be presented to the party at the terminal separately from another indicator such as an indicator from a presence server, or can be presented in combination with another indicator.

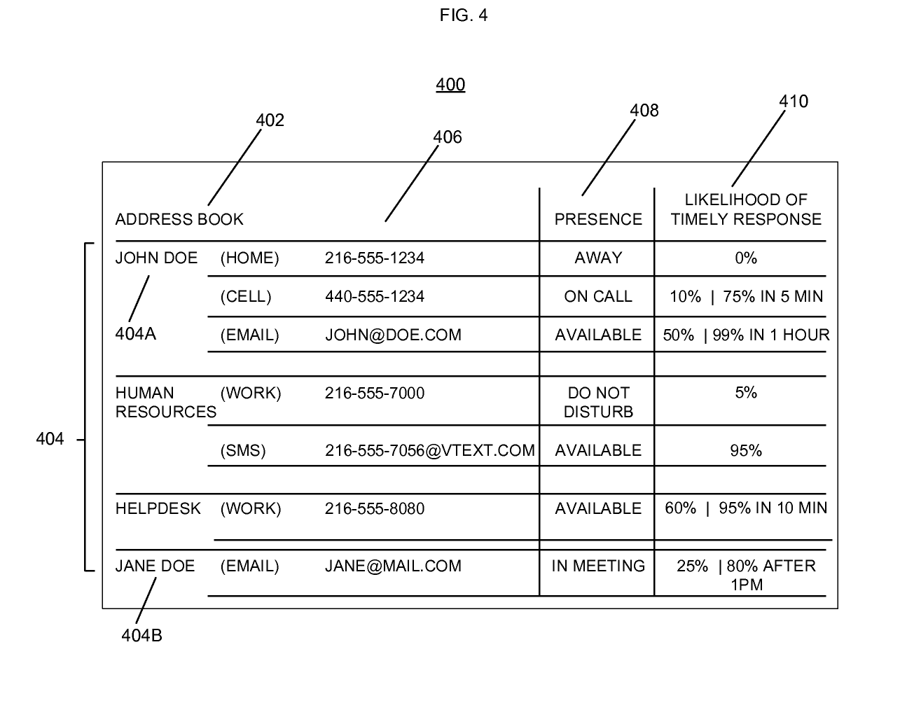

Referring now to FIG. 4, a display 400 illustrating a likelihood of receiving a timely response indicator is presented. The display 400 can be displayed on a desktop phone, a mobile phone, a computer, or a suitable terminal 212. In the display 400, several entries 404 from the address book 402 of a party are displayed. Each entry 404 can include a party of interest's name, a pseudonym or nickname of the party, an address of the party that can be for example an internet protocol (IP) address, and a telephone number of the party, among other information. For each entry 404, several different modalities 406 can be displayed. The modalities that can be displayed do not necessarily have to be supported on the terminal 212 that is presenting the display 400. For example, the display 400 can be presented on a computer that does not support placing voice calls, but the display 400 can still include information regarding different voice call modalities, allowing a user to potentially see a better way to reach the party of interest using a different means of communication. In various configurations, the presence indicator 408 can be displayed for each modality 406, or a subset of the modalities 406, or a single presence indicator 408 can be displayed for an entry 404. For each modality, a likelihood of receiving a timely response indicator 410 can be displayed on the display.

For example, if a party associated with a first entry 404A is away from their home phone, the likelihood of receiving a timely response indicator 410 for that modality 406 can be displayed as 0%. If that party is currently on a call on their cell phone, the likelihood of receiving a timely response indicator 410 for that modality 406 can be displayed as 10%, indicating that 10% of the time when that party is on their cell phone they will response in a timely manner to a new call, for example by placing the current call on hold an answering the incoming call. The likelihood of receiving a timely response indicator 410 for that modality 406 can also display that 75% of the time the party will return a call within 5 minutes, if they don't answer the call. Similarly, the email modality 406 for that party can indicate that emails are answered in a short time frame 50% of the time and answered 99% of the time within 1 hour. In another example, if a party associated with a fourth entry 404B is currently in a meeting, the likelihood of receiving a timely response indicator 410 for receiving a reply email can be displayed as 25% for an immediate response, and 80% for receiving a reply email after the meeting has concluded at 1PM.

The likelihood of receiving a timely response indicators 410 can be based on both modality and other factors. For example, the likelihood of receiving a timely response indicator 410 can be based on the identity of a calling party relative to the called party. The indicator 410 for the first entry 404A could be different for different calling parties, for example 0% if the calling party is not known to the called party (for example, if the calling party is not in the called party's address book), 10% if the calling party is associated with the called party in a team, organizational group, or collaboration, 75% if the calling party is a supervisor of the called party, and 100% if the calling party is a top customer of the called party. Other likelihood of receiving a timely response indicators 410 are possible and can be based on still other factors including any or all of the factors described herein.

Referring again also to FIG. 2, the timely response itself can be based on the modality and message type. For example, a timely response can be a message-based communication from the second terminal 212B to the first terminal 212A, a voicemail from the second party directed to the first party, a call from the second party to the first party, an email from the second party to the first party, an answering of a call from the first party at the first terminal by the second party at the second terminal. A timely response does not necessarily have to be performed using the same modality. For example, a voice call can be responded to with a text message and be considered a timely response.

The time period for a timely response can be based on the modality or message type, and can be configurable. For example, a timely response for a voice call can be the called party answering the call prior to the call going to voicemail. A timely response can alternatively be a return call from the called party within a threshold period of time. A timely response for an email or instant message can be a return message within a period of time based on a preconfigured threshold of time.

A timely response also can be based on trending information available to the LRTR server 202. The trending information can be determined based on past responses by one or more parties. The trending information can be party specific, for example a timely response can be determined from the past response history of that party. The trending information can be based on the typical or average response history of a party. The trending information can be different for each modality or message type. The trending information can be determined for both a long period of time and over a short period of time, for example a window of time within the long period of time. For example, a party may rarely response quickly to an individual caller, but once they are on a project together, the party may respond in a timely manner. The LRTR server 202 can compare the trending information for the long period of time with the trending information in the window of time to analyze changes in response times to messages from one or more parties. The LRTR server 202 can dynamically change indicators based on changes in response times. If the calling party is not in the called party's address book, or if there is no trending information available for the calling party or called party, then the LRTR server 202 can use default rules without regard to trending information. An address book is merely one way of indexing and identifying parties. The LRTR server 202 can also save trending information for parties that are not in the address book.

The indicator can be determined from any suitable information available to the LRTR server 202. Information can include the relationship of the first party to the second party. The relationship can be a familial relationship, a social relationship, a work relationship, and so forth. For example, a work relationship can be a supervisor/supervised relationship or can be inferred from the respective positions of the parties within a company. Other types of work relationship include a seller/customer relationship, a partner/peer relationship, a supplier/buyer relationship, and so forth. This information can be stored in the data store 204 or can be obtained from other sources. For example, the social relationship of two parties can be obtained from a social network.

The LRTR server 202 can receive information from other servers, for example by polling other servers or receiving messages from other servers. In a configuration, the likelihood of receiving a timely response server can receive information from a presence server 208. A presence server 208 can provide indicators to terminals 212 regarding the presence of parties at other terminals 212, as illustrated in FIG. 4 and as describe in the above examples. The presence server 208 receives presence information from the terminals 212 and stores the presence information in a data store 210 associated with the presence server 208. The presence server 208 sends the presence indicators to the other terminals 212, as appropriate. For example, a first terminal 212A can receive indicators from the presence server 208 about a second terminal 212B, and a third terminal 212C. The first terminal 212A can present the indicators on a display to a first party at the first terminal 212A in a suitable format for providing presence information to the first party.

The displayed presence indicators provide the first party with information about the second party and third party, allowing the first party to make intelligent decisions as to whether to call one of the other parties. A first party at the first terminal 212A can review the presence indicators on the display prior to attempting to contact a second party at the second terminal 212B or a third party at the third terminal 212C. For example, if the first party desires to contact the second party, but the presence indicators indicate that the second party is currently on a call, then the first party can wait until the second party is available. The first party can decide to wait until the presence indicator indicates that the second party is at their terminal and available before placing a call to the second party. The first party can also decide to call a different party instead, such as the third party. For example, if the second party is busy but the third party is available, the first party can decide to call the third party based on the third party's availability to accept a call.

The LRTR server 202 can determine the indicator to send based on the availability of the other party. This availability information can be obtained from a presence server 208. Example availability information can include available, busy, in a meeting, on the phone, do not disturb, be right back, offline, away from desk, away for a specific period of time, out of the office, and so forth.

The LRTR server 202 can determine the indicator to send based on the location or geo-position of either party. For example, if the location of the party of interest is determined to be at their place of work, then the party may generally respond more quickly to messages than if that party is offsite, currently travelling (moving), or at home. Similarly, the location of the calling party, or party sending a message, can also be a factor. For example, if a calling party is travelling, and the called party is aware that the calling party is travelling, then the called party may be more likely to respond quickly. For example, a secretary may always take a call from a travelling supervisor, even if they have currently set their terminal to do not disturb. Similarly, a party can be respond differently depending upon whether the message is from a local person or a distant person. For example, if location of the calling party indicates that they are calling from outside of the company, the called party may be more or less likely to respond in a timely manner than if they are calling from inside the same company. Location information can be obtained from a global positioning system (GPS), GPS data, cell tower triangulation, or other suitable positioning systems, methods, or data. Location information also can be obtained from the calling number or address of the parties, and can be used separately from, or in conjunction with information obtained from other services, such as caller ID, call number delivery type services, and directory services.

The LRTR server 202 can also determine the indicator based on the urgency or importance of the message to be sent. Example urgencies can include critical, urgent, time sensitive, non-urgent, and so forth. Example importance settings can be normal importance, high importance, or very important. Messages such as emails that are flagged as being urgent or important tend to be answered more quickly than other messages. Business policies may require that some messages get flagged as being more important or more urgent. Similarly, the LRTR server 202 can also determine the indicator based on a confidentiality setting.

The LRTR server 202 can also determine the indicator based on user configurable setting. For example, a user can set a configuration to provide information to the LRTR server 202 about the likelihood of responding to a message from a particular party or based on particular times of day. For example, a user can set a configuration to indicate that calls from family will always receive a timely response. In another example, a user can set a configuration to indicate that they are not answering any calls until the next morning. Similarly, the LRTR server 202 can be configured to ignore certain factors when determining the indicator. For example, a user can set a configuration to indicate that family, a supervisor, or a call from a key customer account will receiving a timely response even if the user has configured their terminal to display do not disturb or if the LRTR server 202 would otherwise indicate that a timely response was not likely.

The LRTR server 202 can also determine the indicator based on workgroups or subsets of contacts, for example a subset of contacts in the address book of the party. For example, if the LRTR server 202 obtains information that the party is working with a particular group of people, then those people can receive an indicator that is different from the indicator sent to other parties. For example, if a party is currently on a project or otherwise collaborating with several other people, then the LRTR server 202 can provide a different indicator to people associated with the project or collaboration. The relationship can also be determined contextually, either from trending information or from current activity. For example, if a party begins to receive a larger than normal volume of calls from a particular person or group of people, and if the party responds to those communications more quickly than other people, then the LRTR server 202 can infer a group or collaborative relationship.

An example method can include using an algorithm or applying a windowing function to identify trends, past history, recent activity, or other patterns in how the party responds to particular people or groups of people. The LRTR server 202 can use these history factors to determine the indicator to send to the terminal 212. In an example of basing an indicator on current activity, if a party is currently performing an activity, then the indicators presented to people related to or associated with that activity can be different from what is presented to other people. For example, if a party is currently on a call with the helpdesk of an IT (information technology) group, then other members of the helpdesk group may receive indicators that indicate that the party will respond in a timely manner because they may be working on the same or a related problem. Similarly, a party may respond differently to a new voice call than the party would respond to a request to join a multi-party conference call. A party may respond more quickly to a message that follows previous messages in an ongoing message-based dialog, and the LRTR server 202 can change the indicator accordingly. Similarly, if a party recently answered a call from a calling party, then the likelihood of a receiving a timely response can change based on the time elapsed since the last answered call. Similarly, if the party did not respond to a previous message, then the LRTR server 202 can use that information as a factor in setting the indicator for that party.

In another example, the LRTR server 202 can also determine the indicator based on the number and types of terminals available to a party. For example, if the only terminal associated with a party is a cellphone and the party is currently on a call, then the likelihood of receiving a timely response to an instant message or email can be set to a lower value for those modalities as it can be impractical or impossible to use the phone for more than one modality at a time. Similarly, if a party is at their desk and the party has a computer, a desktop phone, and a cellphone, then that party may respond in a timely manner to a text message or an email even if they are currently on a conference call with other parties. The response time can vary on other factors as well, for example the kind of activity that the party is currently participating in. For example, the party may rarely respond to an instant message when they are on the phone or at a customer meeting. But the same party may always respond when they are in a conference call or at a department meeting

The LRTR server 202 can use available information to determine the indicator to send to a terminal 212. The operation of determining can be based on a rule, and use the information as factors in making the determination of the values to use as the indicator. The operation of determining can include a learning operation, for example to determine weighting to apply to the factors. Learning algorithms can include, but are not limited to, decision tree learning, Bayesian type algorithms, associated rule learning, artificial neural networks, inductive logic programming, and reinforcement learning among other suitable learning operations. The history of messaging and communications between parties can be captured as factors to use in making correlations and determining trends that can be used to determine the likelihood of receiving a timely response. The history can be captured on any suitable level of granularity for each of the factors used to determine the likelihood of receiving a timely response. For example history can be captured based on the parties, based on the modalities used by the parties, based on the relationships of the parties, based on historical trends or recent trend information, and so forth. The history data and other data available to the LRTR server 202 can be used to predict the likelihood of receiving a timely response and provide a suitable indicator.

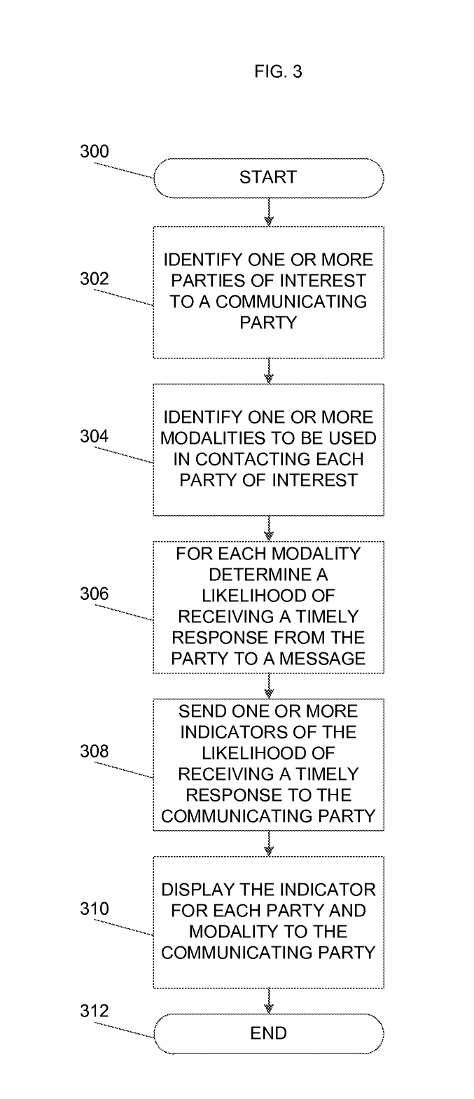

Referring now to FIG. 3, a flow diagram of an example operation of a likelihood response server is presented. Processing starts at start block 300 and continues to process block 302. In process block 302, one or more parties of interest to a communicating party are identified. The communicating party can be a first party that desires to communicate with, or attempts to contact, a second party that is a party of interest. The first party can be a caller and the second party can be the called party. The first party can desire to send an instant message or email to a second party. The parties of interest can be identified, for example, by the first party displaying one or more parties in the first party's address book. A party of interest can be displayed on a terminal of a desktop phone, for example as a result of a search performed on the desktop phone. Processing continues to process block 304.

In process block 304, one or more modalities that can be used to contact or communicate with a party of interest are identified. Each modality is way of contacting or communicating with the party, such as voice communications, instant messaging or email. For example, if a party of interest has a cell phone, but no data plan, then only the voice communication modality may be displayed for that party of interest. If that party of interest also has a desktop phone and computer, then additional modalities of voice, email, and instant messaging can be provided. A party of interest can have multiple voice, multiple instant messaging, and multiple email modalities depending upon the number and kind of terminals associated with the party of interest. Processing continues to process block 306.

In process block 306, for each modality for each party of interest, the LRTR server 202 can determine the likelihood of receiving a timely response from the party of interest for each modality as describe above. The LRTR server 202 determines an indicator correlative to the likelihood of receiving a timely response for each modality. Processing continues to process block 308.

In process block 308, the indicators determined by the LRTR server 202 are sent to one or more terminals associated with the communicating party. Processing continues to process block 310.

In process block 310, a terminal associated with the communicating party can display one or more of the indicators. The indicators can be used by the communicating party in deciding whom to communicate with or whether to attempt to communicate with one or more parties of interest. Processing terminates at stop block 312.

The above descriptions of various components and methods are intended to illustrate specific examples and describe certain ways of implementing an apparatus that can determine a likelihood of receiving a timely response as disclosed and described here. These descriptions are neither intended to be nor should be taken as an exhaustive list of the possible ways in which these apparatuses, systems and modules can be made and used. A number of modifications, including substitutions of systems and modules between or among examples and variations among combinations can be made. Those modifications and variations should be apparent to those of ordinary skill in this area after having read this document.

What is claimed is:

1. A method, comprising:
determining a likelihood that a first party at a first terminal will receive a timely response from a second party to a message initiated by the first party; and
sending to the first party at the first terminal an indicator of the likelihood of receiving a timely response.

2. The method of claim 1, further comprising:
receiving data associated with a presence of the second party at a second terminal, and
wherein the indicator includes the presence of the second party.

3. The method of claim 1, wherein the timely response is selected from the group consisting of
a message-based communication from the second party to the first party,
a voicemail from the second party to the first party,
a call from the second party to the first party,
an email from the second party to the first party,
an answering of a call from the first party by the second party, and
an acceptance of a communication setup request from the first party at a second terminal associated with the second party.

4. The method of claim 1, further comprising:
determining at least one factor that affects the likelihood of the first party receiving a timely response,
wherein the indicator is based at least in part on at least one factor, and
wherein each factor is selected from the group consisting of
a relationship factor of a first party to the second party,
a history factor related to previous communication activity between the first party and the second party,
a rank factor of a communication that is a message-based communication,
an importance factor of the communication to at least one of the first party and the second party,
a presence factor of the second party,
a location factor associated with at least one of the first party and second party,
a relevance factor of the second party to an activity of the first party,
an activity factor of the second party, and
a priority factor related to the priority of an activity of second party in relation to the activity of the first party.

5. The method of claim 4, further comprising:
receiving data associated with a presence of the second party, and
wherein the likelihood of first party receiving a timely response is further based on the presence of the second party.

6. The method of claim 4, wherein the rank factor of the communication that is a message is based at least in part on
a priority factor that is based on at least one of
an importance setting, and
an urgency setting; and
a confidentiality setting.

7. The method of claim 4, wherein the activity factor is based on a collaboration in which the second party is participating, and wherein the modality includes at least one of
a voice based call,
a multi-party conference call,
an ongoing message-based dialog, and
email.

8. The method of claim 4, wherein the location factor is selected from the group consisting of
the location of at least one of the first party and the second party,
the location of the second terminal associated with the second party, and
the location of a third terminal proximate to the second party.

9. The method of claim 4, wherein the history factor is based at least in part on at least one of
a response history of the second party to a communication attempt by the first party,
a response history of the second party to a communication attempt by a third party associated with the first party,
a recent response history of the second party to a communication attempt by the first party,
a response history of the second party to a communication attempt by the first party following a collaboration between the second party and the first party on a project, and
a response history of the second party to a communication attempt by the first party based on a least one of a time of day, a location of the second party, an activity of the second party, and a current mode of the communication.

10. The method of claim 1, wherein the indicator is at least one of
an indicator based on the likelihood that the second party will answer a call from the first party,
an indicator based on the likelihood of a timely response by the second party to a communication request of the first party,
an indicator based on the likelihood of a timely response by the second party to a message of the first party,
an indicator based on a likelihood that the second party will respond, within a threshold interval of time, to a message from the first party,
an indicator based on one or more threshold probabilities of a timely response by the second party,
a color indicator,
a shading indicator,
a percentage indicator,
a step-ranking indicator,
an indicator that is a positive indicator, and
an indicator that is a negative indicator.

11. The method of claim 1, wherein the operation of determining is performed in accordance with at least one of
a user policy,
a business policy,
a rule-based policy, and
a learning algorithm.

12. The method of claim 11, wherein the user policy is further based on at least one of
a sender policy for the first party that includes at least one of
a confidentiality setting
an importance setting, and
an urgency setting; and
a receiver policy for the second party that includes at least one of
an identification of the first party,
a relationship of the first party to the second party,
an activity of the second party,
an activity of the first party,
an activity of the first party identified in the communication,
a mode of collaboration identified in the communication, and
a location of at least one of the first party and the second party, and
wherein the business policy is further based on at least one of
a communication type,
a message type, and
an identity of at least one of the first party and the second party.

13. A method, comprising:
displaying, at a first terminal, an identifying indicia of a party of interest associated with a second terminal; and
displaying, at the first terminal, and in proximity to the identifying indicia, a predicted likelihood of receiving a timely response from the party of interest in response to a message to be sent from the first terminal to the second terminal, and
wherein the predicted likelihood of receiving a timely response is determined at least in part by applying a rule to at least one factor associated with the party of interest that correlates with the likelihood of receiving a timely response from the party of interest.

14. The method of claim 13, wherein the identifying indicia is at least one of a name of the party of interest, a pseudonym associated with the party of interest, an address associated with the party of interest, and a telephone number associated with the party of interest.

15. The method of claim 13, further comprising:
determining at least one factor that affects the predicted likelihood of receiving a timely response from the party of interest, wherein each factor is associated with at least one of
a relationship of a first party associated with the first terminal to the party of interest,
an availability of the party of interest at one of the second terminal and a third terminal,
an activity of at least one of the first party and the party of interest,
a prior communication between the first party and the party of interest, and
a priority indicator associated with a message; and
wherein the predicted likelihood of receiving a timely response from the party of interest is based at least in part on at least one factor.

16. The method of claim 15, further comprising:
receiving data associated with a presence of the party of interest, and
wherein the predicted likelihood of receiving a timely response from the party of interest is further based on the presence of the party of interest.

17. The method of claim 13, further comprising:
displaying, at the first terminal, and in proximity to the identifying indicia and the predicted likelihood of receiving a timely response, a presence identifier associated with the party of interest and second terminal.

18. An apparatus, comprising:
a processor configured determine a likelihood that a first party at a first terminal will receive a timely response from a second party to a message initiated by the first party; and
a transmitter configured to send an indicator associated with the likelihood of receiving a timely response to the first terminal.

19. The apparatus of claim 18, further comprising:
a receiver configured to receive data that correlates with the likelihood of receiving a timely response from the second party, and
wherein the processor is further configured to determine the likelihood that the first party will receive a timely response based at least in part by applying a rule to the data.

20. The apparatus of claim 18, wherein the processor is further configured to
determine at least one factor that correlates with the likelihood of the first party receiving a timely response,
wherein the indicator is based at least in part on at least one factor, and
wherein each factor is selected from the group consisting of
a relationship factor of a first party to the second party,
a history factor related to previous communication activity between the first party and the second party,
a rank factor of a communication that is a message-based communication,
an importance factor of the communication to at least one of the first party and the second party,
a presence factor of the second party,
a location factor associated with at least one of the first party and second party,
a relevance factor of the second party to an activity of the first party,
an activity factor of the second party, and
a priority factor related to the priority of an activity of second party in relation to the activity of the first party.
